(19) United States
(12) Patent Application Publication
(10) Pub. No.: US 2004/0130983 A1
(43) Pub. Date: Jul. 8, 2004

(54) Displacement detection method, displacement detection device and recording apparatus for performing recording on master of information recording medium

(76) Inventors: Masahiko Tsukuda, Osaka (JP); Shinya Abe, Osaka (JP)

Correspondence Address: RATNERPRESTIA, P O BOX 980, VALLEY FORGE, PA, 19482-0980, US

(21) Appl. No.: 10/695,190

(22) Filed: Oct. 28, 2003

(30) Foreign Application Priority Data
Oct. 28, 2002 (JP) 2002-312438

(51) Int. Cl. G11B 7/00

(52) U.S. Cl. 369/44.36; 369/53.19

(57) ABSTRACT

A displacement detection method in which by reflecting a light beam on a surface of an object to be measured, a displacement of the surface of the object is detected from a change of the reflected light beam due to a change of the displacement of the surface of the object, includes the steps of: causing light beams to be incident upon a substantially identical position on the surface of the object from at least two light sources confronting each other substantially; detecting by position detectors directional changes of the light beams reflected on the surface of the object, respectively; normalizing output signals of the position detectors by luminous intensities received by the position detectors, respectively; and calculating a sum or a difference of the normalized output signals of the position detectors.

### BACKGROUND OF THE INVENTION

1. Field of the Invention

The present invention generally relates to a recording apparatus for performing recording on a master of an information recording medium and more particularly, to displacement detection of a surface of a master employed in an electron beam recording apparatus and a recording apparatus for performing recording on a master of an information recording medium through the displacement detection.

2. Description of the Prior Art

Conventionally, in order to perform recording on an information recording medium such as an optical disc, a recording apparatus for performing recording on a master of an information recording medium is employed in which a blue or ultraviolet laser beam is used as a light source. In the laser recording apparatus, a recording beam is converged by using an objective lens having a numerical aperture (NA) as large as, for example, 0.9 and is irradiated over a master having a photosensitive material coated thereon such that recording on the master is performed. In this case, since a depth of focus of the recording beam converged by the objective lens having the large numerical aperture is small, a control mechanism for moving the objective lens in response to displacement of a surface of the master so as to position a focal point of the recording beam on the surface of the master at all times is essential.

Generally, in order to detect a displacement amount of the surface of the master, a further light source for emitting a further light beam having a wavelength which not only is different from that of the recording beam but does not expose the photosensitive material is provided in addition to the light source for emitting the recording beam. Then, the further light beam from the further light source is passed through the same objective lens as for the recording beam so as to be irradiated over the master and motion of its reflected light is detected by one of such detection methods as an astigmatism method and a skew method. Thus, a focal position of the recording beam is controlled by displacing the objective lens in accordance with the detection information by an actuator.

In response to recent trend of the information recording medium towards higher density, it is under consideration to use an electron beam as the recording beam. However, in the case of an electron beam recording apparatus, since it is structurally difficult in contrast with conventional laser recording to pass the further light beam through the objective lens so as to irradiate the further light beam over the surface of the master, another displacement detection device is required to be provided. To this end, the following methods are generally employed. FIG. 10 schematically shows a displacement detection method called an “optical lever method” which has been hitherto used frequently. A laser having a wavelength which does not expose a photosensitive material is used as a light source. Thus, a laser beam from the laser is obliquely incident upon a surface of a master and its reflected light is received by a position detection means such that displacement of the surface of the master is detected from a directional change of the reflected light. Namely, a light beam from a light source 901 is reflected on a surface of a master 902 and its reflected light is received by a position detector 903. As the surface of the master 902 changes its position in the order of A, B and C, the reflected light changes its position on a surface of the position detector 903 in the order of A′, B′ and C′. By detecting the positions A′, B′ and C′ of the reflected light on the surface of the position detector 903, displacement of the surface of the master 902 can be detected. Based on an output signal of the position detector 903, a focal position of an objective lens such as an electrostatic lens for converging a recording electron beam to the surface of the master 902 is adjusted for controlling the focal position of the recording beam as disclosed in, for example, Japanese Patent Laid-Open Publication No. 2002-83758.

However, in the conventional method shown in FIG. 10, displacement of the reflected light on the position detector 903, which is detected as the output signal of the position detector 903, is caused by not only displacement of the surface of the master 902 but tilt of the surface of the master 902. FIG. 11 schematically shows motion of the reflected light in the case where the surface of the master 902 tilts. Especially, displacement of the reflected light due to tilt of the surface of the master 902 increases in proportion to a distance from a point of reflection of the reflected light on the surface of the master 902 to the position detector 903. Hence, as the distance between the point of reflection of the reflected light on the surface of the master 902 and the position detector 903 is increased, a ratio of displacement of the reflected light due to tilt of the surface of the master 902 to that due to displacement of the surface of the master 902 becomes larger. Therefore, since the conventional method of FIG. 10 is readily affected by tilt of the surface of the master 902 to a degree similar to or higher than that of displacement of the surface of the master 902, it is difficult to detect displacement of the surface of the master 902.

Meanwhile, in the conventional laser recording, the further light beam for displacement detection is passed through the objective lens for converging the recording beam so as to detect the displacement amount of the surface of the master 902 as described above. In this conventional recording method, closed loop control for driving the objective lens itself is performed such that the reflected light is irradiated to a predetermined position of the position detector 903 at all times in accordance with the detected displacement amount of the surface of the master 902. Thus, even if intensity of the reflected light irradiated to the position detector 903 changes, the focal position of the objective lens is detected accurately even upon change of detection sensitivity, so that no influence is exerted on control of the focal position of the objective lens.

However, in the conventional electron beam recording, the focal position of the objective lens such as the electrostatic lens for converging the electron beam is adjusted on the basis of the output signal of the position detector 903 such that the focal position of the recording beam is controlled. Hence, in contrast with closed loop control in which control is performed such that the reflected light is irradiated to the predetermined position of the position detector 903, open loop control is performed in which change of the focal position of the objective lens and the output signal of the position detector 903 are independent of each other, so that amplitude of the output signal of the position detector 903 should indicate displacement amount of the master 902. Thus, if the focal position of the objective lens is controlled by the signal amplitude, variations of the signal amplitude appear as variations of the focal position of the objective lens directly. Therefore, the output signal of the position detector 903 should have a fixed amplitude relative to a given displacement amount of the master 902 at all times. As a result, in case the amplitude of the output signal of the position detector 903 varies due to other factors than change of displacement of the master 902, for example, change of film thickness of the photosensitive material coated on the master 902 and variations of output of the light source for a position detection system, such a problem arises that error is produced in information on the focal position of the objective lens for the electron beam.

### SUMMARY OF THE INVENTION

Accordingly, an essential object of the present invention is to provide, with a view to eliminating the above mentioned drawbacks of prior art, a displacement detection method and a displacement detection device, which are capable of detecting a displacement of a surface of a master of an information recording medium by eliminating influence of tilt of the surface of the master and influence of change of quantity of light incident upon a position detection means as well as a recording apparatus for performing recording on the master of the information recording medium, which is capable of positioning a focal point of a recording beam on the surface of the master at all times by using the displacement detection method and the displacement detection device.

In the conventional optical lever method referred to earlier, a signal component caused by displacement of the surface of the master and a further signal component caused tilt of the surface of the master cannot be separated from each other in a detected signal. However, in case light beams are incident upon the surface of the master from two opposite locations, an influence exerted by the signal component caused by displacement of the surface of the master and an influence exerted by the further signal component exerted by tilt of the surface of the master are different from each other in the signal detected by the position detection means.

Therefore, in the displacement detection device of the present invention, since a plurality of, for example, two light beams are incident upon the surface of the master from two opposite locations and directional changes of the light beams reflected on the surface of the master are detected by the respective position detection means, the displacement of the surface of the master can be detected by canceling each other signal components caused by tilt of the surface of the master. Meanwhile, when a signal outputted from each of the position detection means is normalized by a quantity of the reflected light beam irradiated to each of the position detection means, the displacement of the surface of the master can be detected regardless of change of the quantity of the reflected light beam.

Furthermore, when the displacement detection device of the present invention is mounted on the recording apparatus of the present invention for performing recording on the master of the information recording medium, a focal point of a recording beam can be adjusted so as to be positioned on the surface of the master at all times by not only detecting the displacement of the surface of the master but changing a focal position of the recording beam on the basis of the displacement amount of the surface of the master. In case the recording beam and the light beam for detecting the displacement of the surface of the master cannot be irradiated by using an identical lens, for example, an electron beam is used as the recording beam, the present invention is especially useful.

### BRIEF DESCRIPTION OF THE DRAWINGS

This object and features of the present invention will become apparent from the following description taken in conjunction with the preferred embodiments thereof with reference to the accompanying drawings in which:

FIG. 1 is a mimetic diagram explanatory of a displacement detection method and a displacement detection device according to a first embodiment of the present invention;

FIGS. 2A and 2B are mimetic diagrams explanatory of changes of an optical axis of reflected light by displacement and tilt of a master in the first embodiment, respectively;

FIGS. 3A and 3B are mimetic diagrams explanatory of changes of a detection signal by tilt and displacement of the master in the first embodiment, respectively;

FIGS. 4A and 4B are schematic views explanatory of a method of adjusting detection sensitivity of light receiving portions A and B of a photodiode employed in the displacement detection device of FIG. 1, respectively;

FIG. 5 is a schematic view explanatory of variations of an output signal of a position detection means employed in the displacement detection device of FIG. 1;

FIG. 6 is a schematic view explanatory of change of outputs from photodiodes and the position detection means by tilt of the master in the first embodiment;

FIG. 7 is a mimetic diagram showing one example of a normalizing mechanism employed in the displacement detection device of FIG. 1;

FIG. 8 is a mimetic diagram explanatory of a displacement detection method and a displacement detection device according to a second embodiment of the present invention;

FIG. 9 is a mimetic diagram explanatory of a recording apparatus for performing recording on a master of an information recording medium, according to a third embodiment of the present invention;

FIG. 10 is a mimetic diagram explanatory of a conventional displacement detection method; and

FIG. 11 is a mimetic diagram showing motion of reflected light due to tilt of a surface of a master in the conventional displacement detection method of FIG. 10.

Before the description of the present invention proceeds, it is to be noted that like parts are designated by like reference numerals throughout several views of the accompanying drawings.

### DETAILED DESCRIPTION OF THE INVENTION

Hereinafter, embodiments of the present invention are described with reference to the drawings.

### FIRST EMBODIMENT

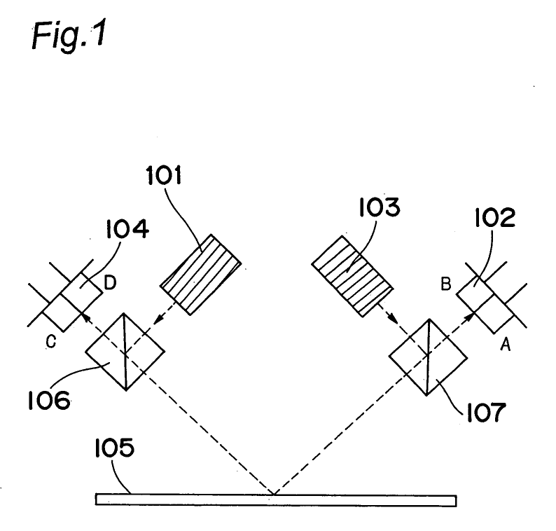

FIG. 1 illustrates a displacement detection method of and a displacement detection device for detecting a displacement of a surface of a master 105 of an information recording medium, according to a first embodiment of the present invention. A first irradiation detection system is constituted by a first light source 101 for emitting polarized light by using a laser diode and a first photodiode 102 having a light receiving face divided into two light receiving portions A and B, while a second irradiation detection system is constituted by a second light source 103 for emitting polarized light by using a laser diode and a second photodiode 104 having a light receiving face divided into two light receiving portions C and D.

The first and second irradiation detection systems are, respectively, synthesized and split by first and second polarization beam splitters 106 and 107. Thus, light beams from the first and second light sources 101 and 103 are incident upon a substantially identical position of the master 105 and are reflected in opposite directions along a substantially identical optical axis through the second and first polarization beam splitters 107 and 106 and 107 so as to be incident upon the first and second photodiodes 102 and 104, respectively.

At this time, a dividing line of the light receiving face of each of the first and second photodiodes 102 and 104 is disposed so as to be substantially perpendicular to an optical path plane of each of the reflected light beams from the master 105, while the reflected light beams from the master 105 are adjusted so as to be positioned on the dividing lines of the first and second photodiodes 102 and 104, respectively. When a difference of signals from the two light receiving portions of each of the first and second photodiodes 102 and 104 is obtained, it is possible to detect positional changes of the reflected light beams on the two light receiving portions, so that a position detection means is formed by the first and second photodiodes 102 and 104 each having the two light receiving portions.

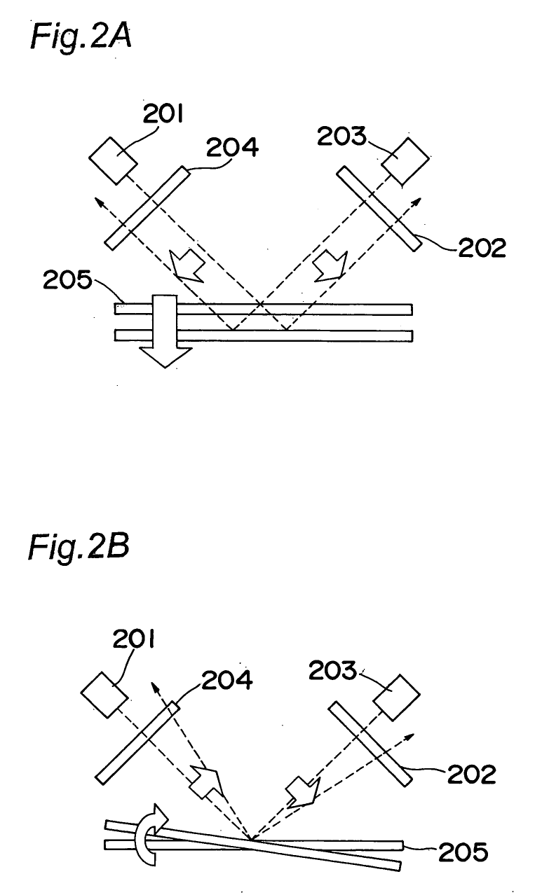

FIG. 2A shows changes of optical axes of the light beams from the first and second light sources 101 and 103 at locations of the first and second photodiodes 102 and 104 by displacement of the surface of the master 105, while FIG. 2B shows changes of optical axes of the light beams from the first and second light sources 101 and 103 at the locations of the first and second photodiodes 102 and 104 by tilt of the surface of the master 105. As shown in FIG. 2A, in an optical path proceeding rightwards from a light source 201 to a screen 202 after reflection on a surface of a master 205 and an optical path proceeding leftwards from a light source 203 to a screen 204 after reflection on the surface of the master 205 in an identical optical path plane, positions of reflected light beams on the screens 202 and 204 change in a direction identical with that of displacement of the surface of the master 205. On the other hand, as shown in FIG. 2B, optical axes of reflected light beams from the light sources 201 and 203 rotate in a direction identical with that of tilt of the surface of the master 205 in contrast with displacement of the surface of the master 205 shown in FIG. 2A.

Therefore, when the position detection means is provided for the two reflected light beams so as to detect changes of the optical axes of the two reflected light beams and a difference or a sum of signals from two portions of the position detection means is obtained such that signal components produced by tilt of the surface of the master 205 cancel each other, only signal components produced by displacement of the surface of the master 205 can be extracted and detected through their multiplication.

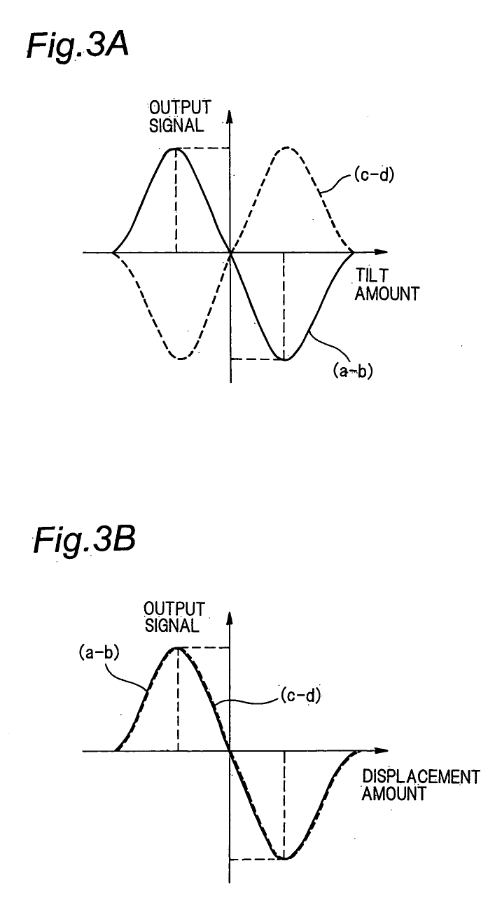

In FIG. 1, the light receiving portion A adjacent to the master 105 and the light receiving portion B remote from the master 105 act as the two light receiving portions of the first photodiode 102, respectively. Similarly, the light receiving portion C adjacent to the master 105 and the light receiving portion D remote from the master 105 act as the two light receiving portions of the second photodiode 104, respectively. Supposing that signals a, b, c and d are, respectively, detected in the light receiving portions A, B, C and D, changes of a signal (a−b) and a signal (c−d) are described with reference to FIGS. 3A and 3B. FIGS. 3A and 3B illustrate the changes of the signal (a−b) and the signal (c−d) by tilt and displacement of the surface of the master 105, respectively. As shown in FIG. 3A, tilt of the surface of the master 105 sets the signal (a−b) and the signal (c−d) to opposite signs, respectively. On the other hand, as shown in FIG. 3B, displacement of the surface of the master 105 sets the signal (a−b) and the signal (c−d) to an identical sign. Therefore, in tilt of the surface of the master 205 shown in FIG. 2B, when a sum of the signal (a−b) and the signal (c−d), i.e., {(a−b)+(c−d)} is obtained in FIG. 3A, the signal components produced by tilt of the surface of the master 205 cancel each other. Meanwhile, in displacement of the surface of the master 205 shown in FIG. 2A, when a sum of the signal (a−b) and the signal (c−d), i.e., {(a−b)+(c−d)} is obtained in FIG. 3B, the signal components produced by displacement of the surface of the master 205 are detected twofold.

Meanwhile, in the first embodiment of the present invention, since the signal (a−b) and the signal (c−d) have polarities shown in FIGS. 3A and 3B for convenience of calculation of the signals a, b, c and d in the light receiving portions A, B, C and D, respectively, the sum of the signal (a−b) and the signal (c−d) is obtained. However, a difference of the signal (a−b) and the signal (c−d) may be employed according to polarities of signal processing in order to exclude influence of tilt of the surface of the master 105.

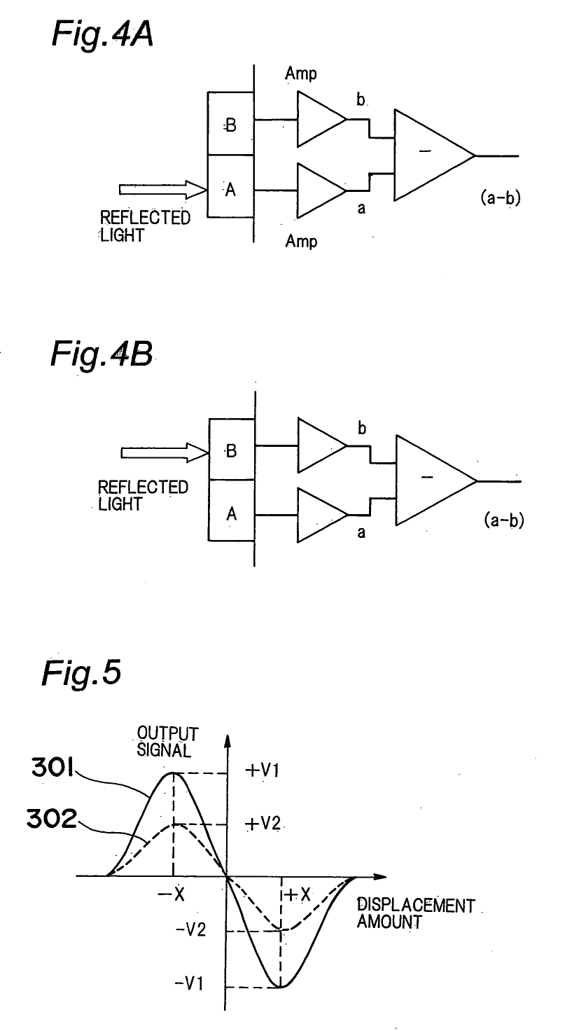

Furthermore, the above description of the first embodiment of the present invention is based on a major premise that the light receiving portions A, B, C and D have an identical detection sensitivity. However, in case the light receiving portions A, B, C and D have different detection sensitivities, a plus or minus peak value of each of the output signal (a−b) and the output signal (c−d) shown in FIGS. 3A and 3B varies, balance of amplitude of the output signal relative to displacement amount is destroyed. As a result, it is necessary to adjust the detection sensitivities of the light receiving portions A, B, C and D as shown in FIGS. 4A and 4B. As shown in FIG. 4A, position of the first photodiode 102 or position of reflected light incident upon the light receiving face of the first photodiode 102 is adjusted such that the reflected light is wholly irradiated to the light receiving portion A. At this time, an intensity of the signal a outputted from the light receiving portion A represents the plus peak value of the signal (a−b) in FIG. 3B. Meanwhile, on the contrary as shown in FIG. 4B, position of the second photodiode 104 or position of reflected light incident upon the light receiving face of the second photodiode 104 is adjusted such that the reflected light is wholly irradiated to the light receiving portion B. At this time, an intensity of the signal b outputted from the light receiving portion B represents the minus peak value of the signal (a−b) in FIG. 3B. Supposing that the light receiving portions A and B have first and second gains of an amplifier circuit, respectively, the detection sensitivities of the light receiving portions A and B can be adjusted by adjusting the first and second gains of the amplifier circuit. By performing similar operations on the second photodiode 104, it is possible to adjust the detection sensitivities of the light receiving portions C and D.

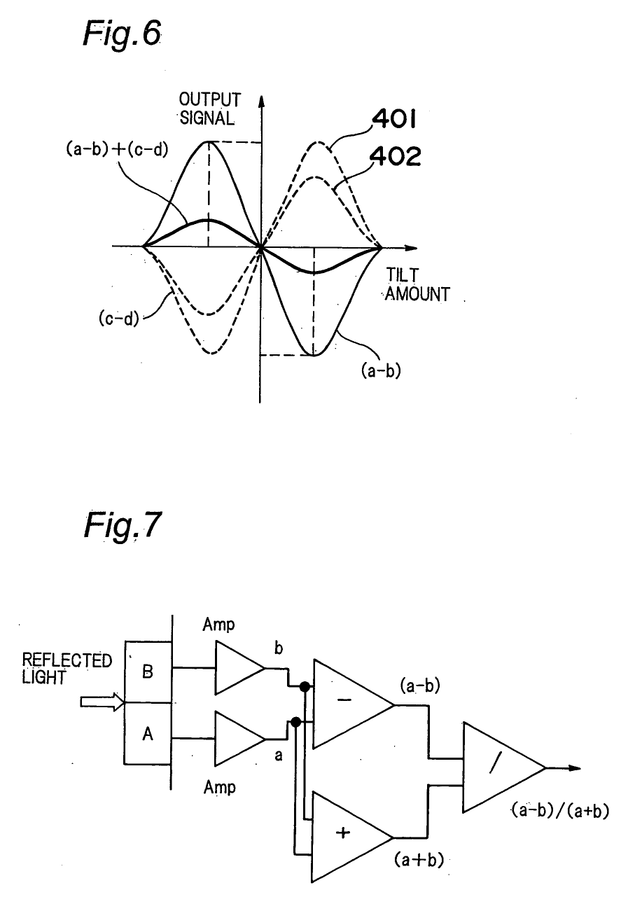

Moreover, in case quantity of reflected light incident upon the photodiode changes upon such change of surface state of the master 105 as change of film thickness of material coated on the surface of the master 105 or change of quantity of light of the light source, output amplitude of the position detection means undergoes changes as shown in FIGS. 5 and 6. Initially, FIG. 5 illustrates change of the output signal {(a−b)+(c−d)} of the position detection means relative to displacement amount of the master 105 in the case where the quantity of reflected light has dropped due to change of the film thickness of the material coated on the master 105, etc. A reference numeral “301” denotes a waveform of the output signal at the time the quantity of reflected light is large, while a reference numeral “302” denotes a waveform of the output signal at the time the quantity of reflected light is small. In this case, since the quantity of reflected light incident upon the first photodiode 102 and the quantity of reflected light incident upon the second photodiode 104 drop similarly, the waveforms 301 and 302 assume plus peak values +V1 and +V2 at a displacement amount of (−X), respectively and minus peak values −V1 and −V2 at a displacement amount of (+X), respectively as shown in FIG. 5, so that an amplitude of the waveform 302 decreases from that of the waveform 301 at a ratio of (V2/V1). If the displacement amount is read from the amplitude of the output signal, reading of the displacement amount involves an error corresponding to the change of sensitivity.

Then, FIG. 6 illustrates change of the output signals (a−b) and (c−d) of the first and second photodiodes 102 and 104 and the output signal {(a−b)+(c−d)} of the position detection means relative to tilt amount of the master 105 in the case where quantity of light of only the second light source 103 has dropped. When the quantity of light of only the second light source 103 has dropped, waveform of the signal (c−d) changes from a waveform 401 to a waveform 402 as shown in FIG. 6. At this time, since a difference between an output amplitude of the output signal (a−b) and that of the output signal (c−d), a signal component caused by tilt appears in the output signal {(a−b)+(c−d)} of the position detection means, so that it becomes impossible to accurately measure only a signal component caused by displacement.

Therefore, in the first embodiment of the present invention, a normalizing mechanism for eliminating an error in reading of displacement amount due to change of quantity of reflected light is provided in each position detection means. FIG. 7 shows one example of the normalizing mechanism provided in the first irradiation detection system. When positional information obtained by the difference signal (a−b) of the signals a and b outputted from the light receiving portions A and B adjusted so as to have an identical detection sensitivity in the first photodiode 102 is divided by a luminous intensity (a+b) inputted to the first photodiode 102, normalized positional information {(a−b)/(a+b)} is outputted. By using such an arrangement, an identical signal amplitude can be outputted for a predetermined displacement amount at all times even if the quantity of reflected light has changed. Meanwhile, when the second irradiation detection system is also provided with a similar normalizing mechanism so as to balance with the first irradiation detection system, an error caused by tilt can be eliminated and thus, only the displacement amount can be measured.

In addition, in the first embodiment of the present invention, the position detection means is formed by the first and second photodiodes 102 and 104 in each of which the light receiving face is divided into the two light receiving portions. However, in the present invention, even if another element capable of detecting optical position, for example, a position sensitive detector (PSD) is employed in place of the first and second photodiodes 102 and 104, the similar effect can be gained.

### SECOND EMBODIMENT

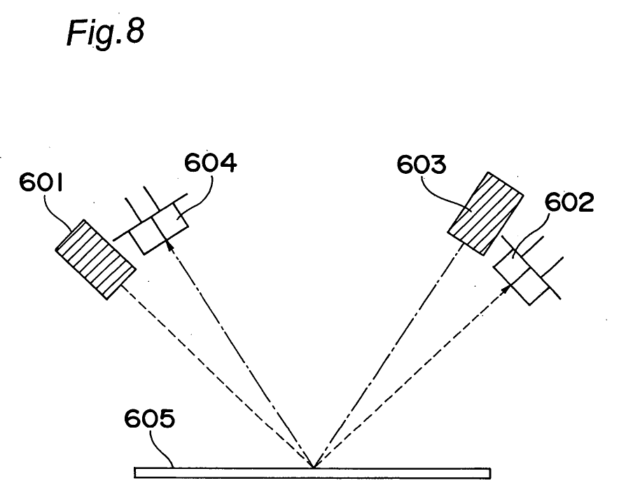

FIG. 8 illustrates a displacement detection method of and a displacement detection device for detecting a displacement of a surface of a master 605 of an information recording medium, according to a second embodiment of the present invention. A first irradiation detection system includes a first light source 601 using a laser diode and a first photodiode 602. As shown in FIG. 8, a light receiving face of the first photodiode 602 is divided into two light receiving portions in a direction substantially perpendicular to a tangent between the light receiving face and an optical path plane formed by light incident upon the surface of the master 605 and reflected light from the surface of the master 605. A second irradiation detection system includes a second light source 603 using a laser diode and a second photodiode 604. As shown in FIG. 8, a light receiving face of the second photodiode 604 is divided into two light receiving portions in a direction substantially perpendicular to a tangent between the light receiving face and an optical path plane formed by light incident upon the surface of the master 605 and reflected light from the surface of the master 605. The first and second irradiation detection systems are provided so as to substantially confront each other such that light beams from the first and second light sources 601 and 603 are incident upon a substantially identical position on the master 605 and then, are reflected from the master 605 towards the first and second photodiodes 602 and 604, respectively.

At this time, a dividing line of the light receiving face of each of the first and second photodiodes 602 and 604 is disposed so as to be perpendicular to a plane of incidence of each of the reflected light beams from the master 605 and the reflected light beams from the master 605 are adjusted so as to be positioned on the dividing lines of the first and second photodiodes 602 and 604, respectively. When a difference of signals obtained from the two light receiving portions of each of the first and second photodiodes 602 and 604 is calculated, it is possible to detect positional changes of the reflected light beams on the two light receiving portions, so that a position detection means is formed by the first and second photodiodes 602 and 604 each having the two light receiving portions.

Also in the above described arrangement, by calculating signals obtained in the light receiving portions of each of the first and second photodiodes 602 and 604, a displacement of the surface of the master 605 can be detected in the same manner as the first embodiment of the present invention.

Meanwhile, in the second embodiment of the present invention, as an angle formed between one set of the light source and the photodiode and the other set of the light source and the photodiode is smaller, an effect that adverse influences exerted on the photodiodes by tilt cancel each other becomes greater. Therefore, it is desirable that this angle is set to be as small as possible.

### THIRD EMBODIMENT

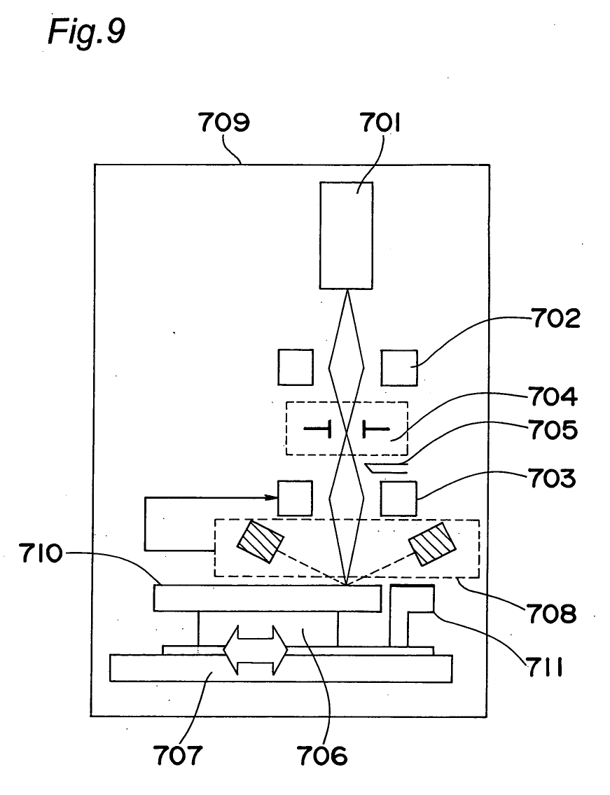

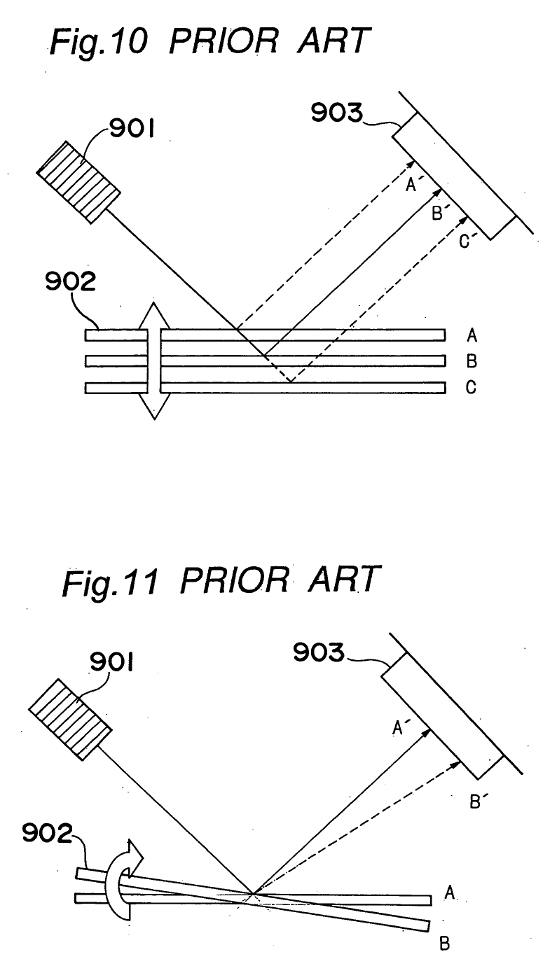

FIG. 9 shows a recording apparatus for performing recording on a master 710 of an information recording medium, according to a third embodiment of the present invention. The recording apparatus includes an electron gun 701 for emitting a recording beam, electrostatic lenses 702 and 703 for converging an electron beam, a deflecting electrode 704 for deflecting the electron beam, a shielding plate 705 for shielding the electron beam deflected by the deflecting electrode 704 so as to modulate the electron beam, a turntable 706 which holds the master 710 coated with photosensitive material so as to rotate the master 710, a slider 707 for moving the turntable 706, a displacement detection device 708 for detecting a displacement of a surface of the master 710, which is described in the first embodiment of the present invention, a focusing grid 711 which is adjusted so as to have a height substantially flush with the surface of the master 710 and on a surface of which a pattern for adjusting a focal position of the electron beam is formed and a vacuum vessel 709 in which the above mentioned members are contained.

By adjusting a focal position of the electrostatic lens 703 on the basis of the displacement amount of the surface of the master 710 detected by the displacement detection device 708, the focal position for converging the electron beam is changed such that a focal point of the electron beam is positioned at a recording point on the surface of the master 710 at all times. A step having a predetermined depth is preliminarily formed on the focusing grid 711. A change of a signal outputted by the displacement detection device 708 during scanning of the step of the focusing grid 711 represents a detected displacement amount of the surface of the master 710 relative to the step in the state. By using this change of the signal of the displacement detection device 708, a signal inputted to the electrostatic lens 703 is calibrated.

As a result, the focal point of the electron beam which is the recording beam can be maintained so as to be positioned on the surface of the master 710 at all times in conformity with displacement of the surface of the master 710 produced upon rotations of the turntable 706. A lattice pattern is formed on the focusing grid 711. By examining a reflected electron image, a secondary electron image, etc. formed during irradiation of the electron beam to the lattice pattern and scanning of a periphery of the lattice pattern, convergence state of the electron beam can be confirmed.

Meanwhile, in this embodiment, the focusing grid 711 is provided in addition to the master 710. However, by either providing a standard sample such as balls of polystyrene latex on the surface of the master 710 or forming a focusing pattern on the surface of the master 710 instead of the focusing grid 711, convergence state of the electron beam can be confirmed.

In the displacement detection device 708, it is desirable that a direction for delivering the light beam is set so as to be perpendicular to a radial direction of the turntable 706. Hence, in case the surface of the master 710 is curved, the surface of the master 710 tilts in accordance with recording radius. However, by delivering the light beam perpendicularly to the radial direction of the turntable 706, the reflected light beam moves in parallel with the dividing line of the light receiving face of the photodiode due to a directional change of the reflected light beam caused by this tilt of the surface of the master 710, so that influences exerted on signals detected at the light receiving portions of the photodiode can be eliminated.

In the third embodiment of the present invention, the light beam of the displacement detection device 708 is set at an irradiation point of the recording beam. However, also by setting, on the turntable 706, the light beam of the displacement detection device 708 at a position having a radius identical with that of the recording beam but having an orientation different from that of the recording beam and calculating time lag from the irradiation point of the recording beam such that the electrostatic lens 703 is adjusted, the focal point of the recording beam can be adjusted. Meanwhile, instead of such real-time displacement detection, also if the displacement amount of the surface of the master 710 is preliminarily measured prior to recording such that the electrostatic lens 703 is adjusted on the basis of the displacement data, the similar effect can be obtained.

Furthermore, in the third embodiment of the present invention, by changing the focal position of the recording beam through adjustment of the electrostatic lens 703, the focal point of the recording beam is maintained at the surface of the master 710. However, also if a mechanism for dynamically changing height of the surface of the master 710 secured to the turntable 706 is provided such that the height of the surface of the master 710 is adjusted in conformity with the displacement amount of the surface of the master 710 detected by the displacement detection device 708, the similar effect can be gained.

As is clear from the foregoing description of the present invention, even when it is difficult to pass the light beam for displacement detection through the lenses simultaneously with the recording beam and a focusing mechanism of open loop control is employed as in the case where the electron beam is used as the recording beam, the displacement detection method and the displacement detection device can be provided which are capable of detecting the displacement of the surface of the master to be recorded, without being influenced by tilt of the surface of the master and change of quantity of the light beam reflected from the surface of the master.

Meanwhile, by mounting this displacement detection device in combination with the control means for controlling the focal position of the recording beam, it is possible to provide the recording apparatus for performing recording on the master of the information recording medium, which is capable of maintaining the focal point of the recording beam at the surface of the master at all times.

What is claimed is:

1. A displacement detection method in which by reflecting a light beam on a surface of an object to be measured, a displacement of the surface of the object is detected from a change of the reflected light beam due to a change of the displacement of the surface of the object, comprising the steps of:
causing light beams to be incident upon a substantially identical position on the surface of the object from at least two light sources confronting each other substantially;
detecting by position detection means directional changes of the light beams reflected on the surface of the object, respectively;
normalizing output signals of the position detection means by luminous intensities received by the position detection means, respectively; and
calculating a sum or a difference of the normalized output signals of the position detection means.

2. The displacement detection method as claimed in claim 1, wherein an optical path plane is formed by the light beam incident upon the surface of the object and the reflected light beam and a position detector having a light receiving face divided into two light receiving portions by a dividing line in a direction substantially perpendicular to a tangent between the optical path plane and the light receiving face acts as each of the position detection means;
wherein by causing the reflected light beam to be incident upon the dividing line of the light receiving face, the position detector detects a position of the reflected light beam from a difference of signals detected at the two light receiving portions of the light receiving face, respectively such that the difference of the signals is normalized by a sum of the signals.

3. The displacement detection method as claimed in claim 2, wherein the two light receiving portions of the light receiving face have a substantially identical detection sensitivity.

4. A displacement detection device for detecting a displacement of a surface of an object to be measured, comprising:
a plurality of irradiation detection systems each of which includes a light source for emitting a light beam to the surface of the object, a position detector for detecting a direction of the light beam reflected on the surface of the object and a normalizing mechanism for normalizing an output signal of the position detector by a luminous intensity received by the position detector;
wherein the light beams from the light sources of the irradiation detection systems substantially confront each other so as to be incident upon a substantially identical position on the surface of the object;
wherein a sum or a difference of the output signals of the position detectors is calculated by using signals outputted from the normalizing mechanisms of the irradiation detection systems.

5. The displacement detection device as claimed in claim 4, wherein an optical path plane is formed by the light beam incident upon the surface of the object and the reflected light beam and a luminous intensity detection element having a light receiving face divided into two light receiving portions by a dividing line in a direction substantially perpendicular to a tangent between the optical path plane and the light receiving face acts as the position detector;
wherein by causing the reflected light beam to be incident upon the dividing line of the light receiving face, the luminous intensity detection element detects a position of the reflected light beam from a difference of signals detected at the two light receiving portions of the light receiving face, respectively;
wherein the normalizing mechanism normalizes the difference of the signals by a sum of the signals.

6. The displacement detection device as claimed in claim 5, wherein the two light receiving portions of the light receiving face have a substantially identical detection sensitivity.

7. A recording apparatus for performing recording on a master of an information recording medium, in which the master has a recording material, comprising:
a rotational mechanism for holding and rotating the master;
a displacement detection device for detecting a displacement of a surface of the master, which includes a plurality of irradiation detection systems;
wherein each of the irradiation detection systems includes a light source for emitting a light beam to the surface of the master, a position detector for detecting a direction of the light beam reflected on the surface of the master and a normalizing mechanism for normalizing an output signal of the position detector by a luminous intensity received by the position detector;
wherein the light beams from the light sources of the irradiation detection systems substantially confront each other so as to be incident upon a substantially identical position on the surface of the master;
wherein a sum or a difference of the output signals of the position detectors is calculated by using signals outputted from the normalizing mechanisms of the irradiation detection systems; and
an irradiation means for irradiating a recording beam to the surface of the master at a focal position of the recording beam on the basis of an information signal to be recorded such that the focal position of the recording beam is changed in accordance with the displacement detected by the displacement detection device.

8. The recording apparatus as claimed in claim 7, wherein a step of a predetermined depth is provided on the surface of the master or at a height substantially identical with the surface of the master;
wherein by detecting a sensitivity of the displacement detection device from a signal outputted upon scanning of the step by the displacement detection device, a signal for the irradiation means is corrected.

9. The recording apparatus as claimed in claim 7, wherein the recording beam is an electron beam.

10. The recording apparatus as claimed in claim 7, wherein a pattern for adjusting the focal position of the recording beam is formed on the surface of the master or at a height substantially identical with the surface of the master.
